(19) United States
(12) Patent Application Publication
(10) Pub. No.: US 2014/0247062 A1
(43) Pub. Date: Sep. 4, 2014

(54) Device and method to measure the permeation rate of a packaging

(71) Applicants: Eduard BALTHES, Ingelheim am Rhein (DE); Mathias BRAUN, Sohren (DE)

(72) Inventors: Eduard BALTHES, Ingelheim am Rhein (DE); Mathias BRAUN, Sohren (DE)

(73) Assignee: BOEHRINGER INGELHEIM INTERNATIONAL GMBH, Ingelheim am Rhein (DE)

(21) Appl. No.: 14/093,725

(22) Filed: Dec. 2, 2013

(30) Foreign Application Priority Data
Dec. 6, 2012 (EP) 12195956.3

(51) Int. Cl. G01N 27/22

(52) U.S. Cl. CPC G01N 27/22
USPC 324/671

(57) ABSTRACT

A device for determining the average layer thickness l of a planar packaging material for pharmaceutical packaging, particularly blisters and/or bottles, by means of a capacitive measurement, in which the opposing outer surfaces of the packaging material are provided with electrodes.

### BACKGROUND

The invention relates to a device for determining the average layer thickness and the permeation rate of a packaging, particularly a blister, and a method therefor.

Potent medicaments, particularly new pharmaceutical products, are frequently sensitive in particular to the effects of moisture and, in many cases, to oxygen or light. To ensure the product stability the packaging must adequately protect a sensitive pharmaceutical product (particularly those for oral and inhalative administration) from all relevant environmental influences during storage and time in use. On the basis of fundamental investigations into specific pharmaceutical active substances and pharmaceutical formulations of these active substances the correlation between the water content of the product and the product stability is generally known as the main factor critical to stability.

The foil containers made from the packaging material or the cavities of a blister pack serve as pharmaceutical packaging for, among other things, protecting pharmaceutical active substance formulations from environmental influences that may affect the pharmaceutical quality of the active substance formulation under certain circumstances. One of the factors that determines quality is the moisture acting on the active substance, which on the one hand may penetrate from outside by permeation or may originate from the packaging material itself and enter the cavity from the inner wall of the material. As the blister pack is designed to be well protected against permeation from outside, any moisture present in the cavity is unable to escape and may therefore lead to damage to the active substance. In such cases, the moisture content of the product before packaging and optionally that of foils/films used for producing blister packs must therefore be monitored and if necessary reduced by drying.

A blister pack for a pharmaceutical product (e.g. tablet or capsule) generally consists of a cover film and a base film, the cavities being formed in the base film. The cover film and the base film may be made up of one or more layers of different or identical materials. The cover film is sealably connected to the base film for example by adhesion, welding or sealing. The cover film and/or the carrier film is generally embodied as a metal and/or plastics and/or paper film. These materials may be present in numerous layers. Typical metal films comprise for example aluminium films and composite aluminium films made from aluminium and a plastics, for example. The material used for the plastics films may be polyvinylchloride (PVC), cycloolefin copolymer (COC), polychlorotrifluoroethylene (PCTFE), polyethylene (PE), polypropylene (PP), polyethylene terephthalate (PET), polycarbonate (PC), polyester (UP), polyacrylate, polyamide (PA) or other plastics. Often, a blister consists of a cover film of aluminium that closes off the base film to accommodate the pharmaceutical product or active substance. This thermoformed base film may also comprise an aluminium film to prevent water from entering the cavity that accommodates the pharmaceutical product. To create a further diffusion barrier or to increase the mechanical stability of the blister, optionally at least the aluminium film of the base film may be covered on one or both sides with additional plastics and/or paper films.

To ensure sufficient product stability of the packaged product in this way it is important to determine the amount of water that enters the packaging by permeation during the storage and period of use of the product. On the basis of the permeation rate of the packaging means it is possible to calculate the ingress of moisture over the storage period and hence estimate the actual effect of water on the packaged product.

The permeation rate is defined as the amount of water that can be exchanged at a given temperature per unit of time at a moisture gradient of 100% r.h. between the outside and inside of a packaging. The permeation rate constitutes an important variable in characterising the barrier and hence protective effect of the packaging. Particularly for oral and inhaled medicaments, a high barrier film is often needed in order to sufficiently prevent water vapour permeation and hence ensure the product stability. The permeation rate is then in the range from a few μg to several hundred μg of water vapour per day.

A number of methods of determining the permeation rate (both qualitatively and quantitatively) are known from the prior art. For example, the quality of the seal of a bottle can be determined using the blue bath test. Different variants are in use, the basic idea of which is described as follows. An empty, sealed bottle is placed in a desiccator filled with water dyed with methylene blue such that the bottle is completely covered by water. Then a negative pressure is generated in the desiccator for a specific length of time. If the bottle has no serious leaks (case 1), the subsequent ventilation of the desiccator will have no effect on the bottle. However, if the bottle is leaky (case 2), a negative pressure will also be formed in the bottle during the phase in which a negative pressure is present in the desiccator, as air is escaping. When the desiccator is then ventilated, water is sucked into the bottle. If the bottle is then cut open at the base, in the first case no liquid will be seen in the bottle, whereas in the second case there will be anything from a few drops to larger quantities of blue-stained water. In case 1 the bottle is deemed to be “leaktight”, while in case 2 it is deemed to be “leaky”. The blue bath test does not reflect the real situation during storage of the bottle in numerous respects, particularly with regard to the permeation of water vapour. On the one hand, the blue bath test uses liquid water, whereas in the storage phase the bottle comes into contact only with water vapour. Crucial to the water permeation properties of a material are its interactions with water, particularly in vapour form. On the other hand, in the blue bath test, a negative pressure of up to 500 mbar is additionally applied. These extreme conditions eventually lead to mechanical deformation of the bottle, which means that they are no longer comparable with the storage conditions in a real scenario.

Moreover, the blue bath test does not provide any quantitative statements as to the permeation rate but merely defines the qualitative criterion of “leaktight” or “leaky” as described above. Even a bottle evaluated to be “leaktight” in the blue bath test may have such a high permeation rate, for example as the result of local shrinkage of the material, that the product contained therein is damaged. Moreover, the blue bath test does not provide any statement as to the quality of seal of the bottle in different climatic zones.

Another method (hereinafter also referred to as the gravimetric method) for determining the permeation rate is a process which is a modification of the permeation test as described in USP-671 (US Pharmacopeia). For this, as large a water reservoir as possible is packed in a packaging (blister or bottle), giving rise to a relative humidity of around 100% r.h. Then the bottle or the blister is stored in a very dry environment (e.g. a glovebox or in the desiccator with desiccant) at a specified temperature. As a result of the partial pressure difference, water vapour diffuses out of the packaging into the environment, causing the blister or the bottle to lose mass. This loss of mass as a function of the storage time can be recorded using very accurate analytical scales. The permeation rate can be calculated by a suitable evaluation of the measured data. One of the serious disadvantages of this method is the long measuring time. For example, a polymer blister with the high barrier material Aclar® has a very low permeation rate. Consequently, the loss of mass from the blister per unit of time is very low. Now, in order to determine the permeation rate with sufficient accuracy, very long measuring times (up to 100 days) are needed. This method is certainly very accurate, but not suitable when a permeation rate is low and/or has to be determined quickly. Thus, even the modified USP-671 test is not sufficiently suitable for checking the permeation of high barrier packaging for sensitive products. In the USP-671 test itself, the permeation rate is determined after 14 days, which is too slow for “in-process control” (IPC) and does not provide the necessary accuracy for development purposes. It should be emphasised that even this long measurement time is still too fast for some packaging systems, e.g. those based on PVdC material, as over this period this material has just relaxed to ambient conditions, depending on the measuring temperature, and the actual unfalsified permeation process only starts after this. Another method of determining the permeation rate is based on direct measurement of the trace moisture (cf. also: “Trace moisture measurement with quartz crystal microbalance Technology”, VDI-Berichte [0083-5560], author: G. van Haltern; year: 2003, volume: 1784; page: 81-86). In the trace moisture method, the moisture-laden specimen is produced analogously to the gravimetric method. The specimen is then placed in a measuring chamber which is flooded with a stream of dry nitrogen. After any water adhering to the surface of the measuring chamber and the specimen has been evaporated off, the nitrogen only carries the water that has emanated from the specimen by permeation. This current of nitrogen with water vapour can be investigated with a very moisture-sensitive detector and in this way the permeation rate can be determined. This method is very accurate. However, there is the disadvantage that the preparation of the specimen, the calibration of the detector and the evaluation of the measuring curves are very laborious. At very low permeation rates a plurality of specimens have to be prepared to ensure a sufficiently high concentration of water vapour in the nitrogen flow. Moreover, with certain multi-layer high barrier materials (for example PVC-PVdC films) there are very long relaxation times which are also dependent on the layer thickness (about 14 days), before the state of equilibrium needed for permeation measurement is reached.

Another method (Mocon measurement) for determining the permeation rate is based on a process which uses the permeation measuring equipment supplied by Mocon (represented in Germany by Lippke: PAUL LIPPKE HANDELS-GMBH, Industriegebiet Friedrichshof, Carl-Borgward-Straβe 10, D-56566 Neuwied, GERMANY). Using this method the permeation rate of a flat film can be measured in a temperature range of 10-40° C. The schematic structure is shown in FIG. 1 (schematic structure of a permeation measuring device (Permatran-W®3/33) obtained from Messrs Lippke for determining the transmission rate of a flat film). For this, the flat film (8) to be examined is clamped very tightly in the apparatus under high mechanical pressure, (13) indicates sealing rings (O-rings) that seal off the halves of the measuring chamber (7) and (12) relative to the film (8). On one side, flushing is carried out with dry nitrogen (the reference numeral (5) indicates the inlet for the dry nitrogen current and (6) represents the outlet for the nitrogen current travelling past the film) and on the other side (corresponding to the measuring chamber half (12)) a relative humidity of 100% is produced (if desired, humidities in the range from 35-90% r.h. can be generated), while (9) represents the inlet for the moistened gas current and (11) indicates the outlet, and (10) a sensor for monitoring the relative humidity in the measuring chamber half (12). The area and thickness of the film are generally known. As a result of the partial pressure difference on both sides, water vapour diffuses through the film and is absorbed by the nitrogen. The nitrogen that has been guided past the film (outlet (6)) is then transported to a moisture detector and can then be detected in a similar way to the trace moisture measurement in a gas (cf.: “Trace moisture measurement with quartz crystal microbalance Technology”, VDI-Berichte [0083-5560], author: G. van Haltern; year: 2003, volume: 1784; page: 81-86). The result represents the transmission rate of the film at a specific temperature. A disadvantage is that the permeation coefficient can only be concluded from the transmission rate for films of known thickness and area. Thus, it is very difficult to carry out quantitative determination of the permeation rate for thermoformed blister films or bottles and other shaped packages as the wall thicknesses vary. The calibration of the measuring device and the sample preparation are very complicated. Because of intrinsic properties of the different film materials, particular measuring times have to be adjusted. The very long and thickness-dependent relaxation times described above for specific multi-layer high barrier materials (such as PVC-PVdC films) are also crucial here. Thus, this method also does not constitute a quick method of determining the permeation rate that can be carried out at reasonable cost while being sufficiently accurate and reliable. Moreover, the required background knowledge of the film properties can only be obtained in conjunction with a DVS scale.

A DVS scale (Dynamic Vapour Sorption scale) is used primarily to measure the sorption and diffusion properties of solids and powders. The DVS scale is a very sensitive beam balance (manufactured for example by Surface Measurement Systems (SMS)). A reference pan is suspended at one end of the beam and a specimen pan at the other end. The symmetrical construction is required to prevent falsification of the measurement of mass by being driven upwards in the moisture-laden gas current. The end with the specimen pan is provided with a specimen (e.g. PVC film) and a nitrogen current with a defined water vapour content (0-98% r.h. with an accuracy of 1.5% r.h.), at a constant temperature in the range 10-40° C., is passed over it. It is thus possible to investigate the change in mass as a function of the measuring time at a defined temperature and an adjustable and constantly maintained rel. humidity in the nitrogen current. The so-called sorption isotherms are obtained and from these the diffusion constant is calculated as a function of the relative humidity. The product of the two measured values is the permeation coefficient. A disadvantage is that the specimen preparation, the measurements and their interpretation are very time-consuming and require trained and very experienced staff. Also DVS scales are very sensitive, so that even modern equipment is limited to a maximum specimen mass of about 1 g. Therefore, it is possible to examine at most individual blister cavities, but not whole blister cards, bottles and other larger packaging. From DVS measurements, both the sorption capacity and the sorption kinetics can be determined at the same time. The latter is important, for example, for estimating/adjusting the required relaxation time in Mocon measurements.

The problem is thus to provide a sufficiently rapid, simple, accurate and reliable method of determining the average layer thickness and permeation rate of test or market packaging. Particularly during production (packaging of medicaments) as a rapid in-process control, but also within the framework of packaging and process development of packaging for a medicament, the provision of such a method is a major advance in ensuring product quality.

### SUMMARY

Surprisingly, the problem is solved by the device and method according to the invention for determining the average layer thickness by capacitive measurement of the workpiece (packaging material or packaging unit) with a known material-specific relative dielectric constant ∈ᵣ and a known area A. In particular, the invention proposes a device and a method for determining the permeation rate by capacitive measurement.

Fick's diffusion equation applies here, which can be written as follows for a linear system with a location coordinate x and constant diffusion coefficient D:

$$F = - D \frac{\partial C}{\partial x} ,$$

where F is the transmission rate per unit of area A and C is the concentration of the diffusing substance. From this the transmission rate is calculated, for example, for a film of thickness l in a Mocon apparatus, from the difference in the water vapour concentrations C₁ and C₂ on both sides and after a sufficient length of time a state of equilibrium is obtained:

$$F = D \frac{{C}_{1} - {C}_{2}}{l} .$$

Looking at water vapour (in contrast to oxygen as the stability-limiting factor for the medicament formulation) it is not easy to determine the concentration, but the partial pressure p. can be determined. Assuming that the diffusion coefficient is constant and the sorption isotherm of the material is linear, so-called Henry's law applies:

C=Sp,

in which the proportionality constant S describes the solubility of water vapour in the material. Using the ideal gas equation

$${P}_{0} V = \frac{m}{{M}_{{H}_{2} O}} R T$$

with the universal gas constant R, the temperature T, the molar mass of water M_{H2O}, the total pressure P₀, the volume V and the correlation F=\dot{V}/A, the following equation is obtained for the change in mass over time (permeation rate \dot{m})

$$\dot{m} = P \frac{A}{l} Δ {P}_{{H}_{2} O} \frac{{M}_{{H}_{2} O} {P}_{0}}{R T} . \qquad ( 1 )$$

The material properties of the packaging are reflected in the permeation coefficient P=D·S. Thus, using formula (1) it is possible to determine the permeation rate of a flat film if the ratio of area to thickness is known.

For standard materials, the permeation coefficient as a material variable is optionally known from the relevant prior art. If this variable is not known for a particular material and/or the particular material variable is not known with sufficient accuracy from the prior art, or if for example the permeation properties of thermoformed films are not known, it is possible to estimate the permeation coefficient from the transmission rate, if the transmission rate is known.

### BRIEF DESCRIPTION OF THE DRAWINGS

FIG. 1 is a schematic structure of a permeation measuring device;

FIG. 2 is a schematic illustration of a measuring arrangement/device in accordance with one or more embodiments of the invention;

FIG. 3 is a digitized reproduction of an actual structure for implementing the measuring arrangement/device shown in FIG. 2;

FIG. 4 is a schematic illustration of a measuring arrangement/device in accordance with one or more further embodiments of the invention; and

FIG. 5 is a schematic illustration of a measuring arrangement/device in accordance with one or more still further embodiments of the invention.

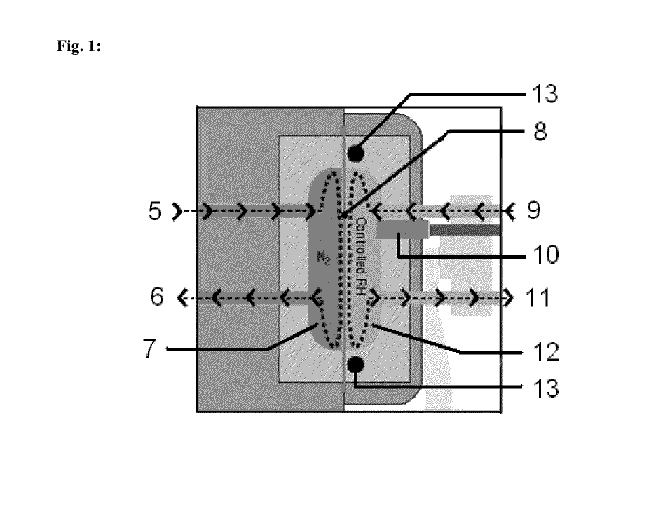

### DETAILED DESCRIPTION

The method according to the invention proposed here for determining the permeation rate \dot{m} of a packaging system is based on the measurement of the critical ratio between the area of a packaging unit A and the associated thickness l of the packaging material. Thus A/l counts as the determining measurement for the permeation rate. The integral ratio A/l is capacitively determined with the aid of the dielectric properties of the material.

It is known that the capacity C of a plate condenser can be calculated using the following formula:

$$C = {ɛ}_{r} {ɛ}_{0} \frac{A}{l} . \qquad ( 2 )$$

The area of the plates is, the spacing of the plates is l and between the plates is a dielectric with the relative dielectric constant ∈ᵣ.

The capacitance C of the capacitor is thus determined by the dielectric constant of the vacuum ∈₀, by the frequency-dependent material-specific relative dielectric constant ∈ᵣ and precisely by the ratio A/l. As the permeation rate \dot{m} is directly proportional to A/l, the permeation rate \dot{m} can be concluded from a measurement of the capacitance of a packaging. The following applies:

$$\dot{m} \sim \frac{A}{l} \sim C . \qquad ( 3 )$$

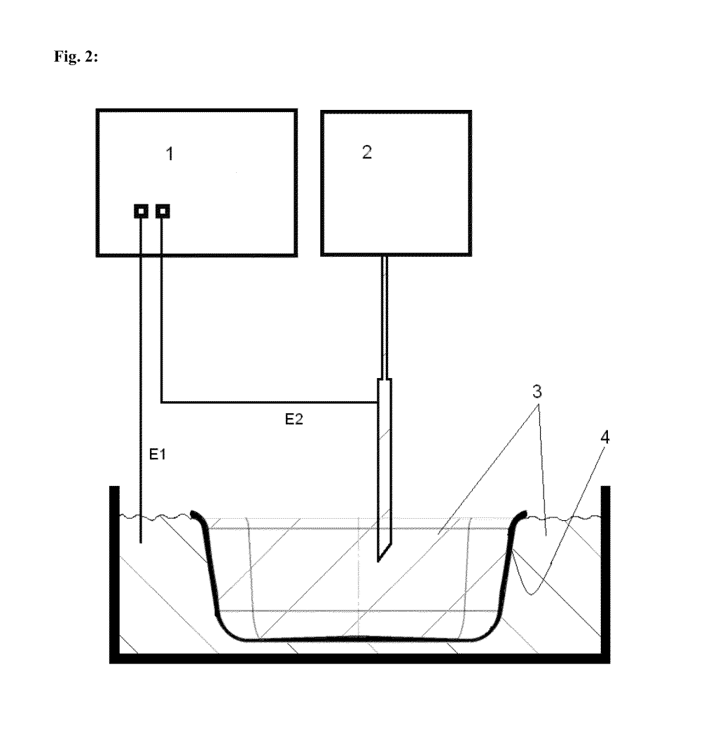

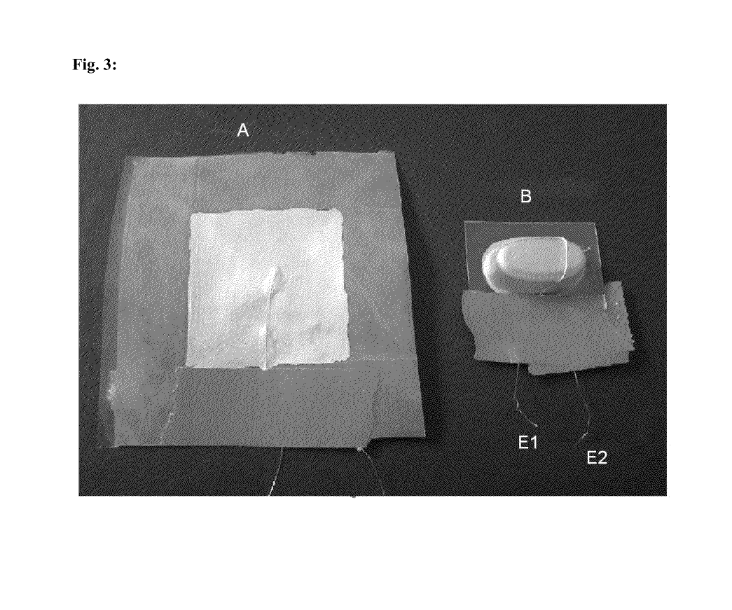

According to the invention, the average layer thickness and the permeation rate of a packaging can be determined with a specific measuring arrangement/device. For example, the structure of such a device is shown in FIG. 2 and the experimental embodiment is shown in FIG. 3. The packaging to be investigated on the opposing outer surfaces is provided with electrodes. This can be achieved, for example, by positioning a packaging component, e.g. a blister well (4) in a bath of conductive liquid (3), the inner cavity (which corresponds to the opposite surface to the outside of the blister well) also being filled with a conductive liquid (3). Alternatively, the surface of the packaging being investigated can also be covered with a conductive layer and connected directly to the electrodes (E1) and (E2) (cf. FIG. 3, left-hand side: calibration film with conductive coating and electrode wires (A); right-hand side: blister with conductive silver (B) and electrodes (E1) and (E2)). The capacitance measured with this device is a measurement of the integral ratio of A/l and thus allows conclusions to be drawn as to the permeation rate. The measuring arrangement shown in FIG. 2 however is not restricted to blisters: bottles and/or other packaging systems can be investigated in this way.

A measuring arrangement according to FIG. 2 makes it possible to investigate individual areas of the blister, in addition to measuring the complete blister. In this special embodiment, the electrode E2 should be modified so as to be in electrical contact only with a partial region of the inner surface. This can be achieved, for example, if the addition of an electrically conductive liquid from a filling station (2) is carried out only in small amounts, so that only a partial region, e.g. the base of the blister well, is filled with the electrically conductive liquid. In this way it is possible to determine the capacitance and finally the ratio A/l as a function of the fill level. With this special embodiment of the method or device proposed here, it is possible to investigate the cavity of an individual blister well, for the development of blisters, or the base convexity of a packaging bottle in spatially resolved manner in order to optimise the manufacturing process. An analogous procedure can be used with all packaging components that require investigation, by limiting the conductive surfaces that are connected to the electrodes E1 and E2 to the surface of the packaging component that is to be investigated. In this way it is possible to investigate packaging quickly and with sufficient spatially-resolved accuracy in terms of their material thickness. A spatially resolved measurement of the average layer thickness of shaped packing components (e.g. blister well, bottle base) for estimating the permeation rate of a packaging means proves advantageous for optimising the shape of a blister cavity or in the scope of minimising the sixe of blister cards and choosing the punch, optimising the thermoforming process within the scope of developing a thermoforming process for a blister. In particular, when carrying out the method it is important to ensure that the electrodes cover the region of the packaging that contributes to the permeation and that the electrically conductive liquid has good coverage of the surface, for example by the addition of an agent (e.g. a surfactant) for reducing the surface tension. A suitable capacitance measuring device is for example a measuring instrument made by HP, model 4274A Multi-Frequency LCR Meter. This measuring instrument has the advantage that not only can DC fields be applied, but also the capacitance can also be measured at different frequencies.

The problem of the invention is thus solved by a device for determining the average layer thickness l of a flat packaging material for pharmaceutical packaging, particularly blisters and/or bottles, by capacitive measurement, wherein the opposing outer surfaces of the packaging material are provided with electrodes, so that the average layer thickness l can be obtained by measuring the capacitance for a known material-specific relative dielectric constant ∈ᵣ and with a known area A of the electrodes, the device 2 comprising electrodes between which the packaging material is inserted and the electrode surface A corresponds to the surface of the packaging, between the surface of which the average layer thickness is to be determined.

In one particular embodiment, the device according to the invention is characterised in that the device consists of a measuring chamber into which the packaging material is clamped, so that two separate measuring chamber halves are produced which are separated by the packaging material, the two opposing surfaces of the packaging material in the two measuring chamber halves being connected to the electrodes.

In another particular embodiment, the device according to the invention is characterised in that the measuring chamber halves are filled with an electrically conductive liquid, so that the opposing surfaces of the packaging material between which the average layer thickness is to be determined are connected to the electrode terminals in electrically conductive manner.

According to the term “capacitive determination” refers to the measurement of the electrical capacitance of a sample (in the particular packaging material). The terms “packaging material”, “flat packaging material”, “packaging component”, “flat packaging component” are of equivalent meaning according to the invention in terms of the feasibility and scope of protection of the present invention. By a calibrating film is meant a crude packaging means which has not been adapted to the particular requirements of the packaging purpose in terms of its shape. This means that, for example, the film from which a blister is to be formed, is not present as a thermoformed calibrating film but is still on a roll, for example. In comparable manner a flat moulded body of known thickness and area that can be produced from the raw material (e.g. granulated plastics) from which the moulded packaging components (e.g. packaging bottle) is produced can also be regarded as a calibrating film.

The aim of the invention is thus solved by a method of determining the average layer thickness l of a planar packaging material for pharmaceutical packaging, particularly blisters, wherein the capacitance is measured by means of 2 electrodes applied to the opposing outer surfaces of the packaging material, so that using the material-specific relative dielectric constant ∈ᵣ and the known area A of the electrodes the average layer thickness l can be calculated, characterised in that in the method the electrode area of the two electrodes corresponds to the area of the packaging means between whose surface the average layer thickness is to be determined.

In one particular embodiment, the method according to the invention for determining the average layer thickness l of a planar packaging material for pharmaceutical packaging is additionally characterised in that it is carried out with the aid of the device according to the invention.

The invention also encompasses a method for determining the permeation rate \dot{m} of a planar packaging material for pharmaceutical packaging within the scope of quality control inspection of packaging components, comprising the partial steps (i) and (ii), where
(i) denotes the measurement of the permeation rate \dot{m} of a planar packaging material by a method known in the prior art and measurement of the capacitance and assigning the value of the capacitance measurement to the permeation rate \dot{m} and
(ii) denotes the measurement of the capacitance of other workpieces of the planar packaging material for pharmaceutical packaging within the scope of quality control inspections of packaging components.

The invention also encompasses a method for determining the permeation rate \dot{m} of a packaging component for pharmaceutical packaging comprising the partial steps (a) and (b), where
(a) comprises determining the relative dielectric constant ∈ᵣ on a flat film (=calibrating film), this flat film having a defined thickness (or a thickness which is determined by a method known from the prior art) and a defined area A (or the area A is determined by a method according to the prior art) and the calibrating film has the same material quality (composition) as the packaging component that is to be inspected and
(b) comprises determining the capacitance C of the packaging component, wherein the opposing outer surfaces of the packaging component are provided with electrodes and the electrode area A of the two electrodes corresponds to the area of the packaging component, for whose area the ratio A/l is to be integrally determined,
   and the permeation rate \dot{m} can be obtained by inserting the measured value in the equation

$$\dot{m} = P \frac{A}{l} Δ {P}_{{H}_{2} O} \frac{{M}_{{H}_{2} O} {P}_{0}}{R T}$$

when the permeation coefficient P is known.

In one particular embodiment, the method according to the invention for determining the permeation rate \dot{m} of a packaging component for pharmaceutical packaging is characterised in that the determination of the capacitance C according to the partial step (b) is carried out using a device according to the invention.

The proposed method according to the invention for determining the average layer thickness and the permeation rate of a packaging means is suitable for packaging means, particularly planar packing components, as blister films, thermoformed blister films. medicine bottles, parts of medicine bottles, which have no or very little or negligible electrical conductivity with respect to the gradient described by the layer thickness. In particular, the method is suitable for any desired electrically non-conductive or virtually non-conductive packaging that can be placed or clamped in the device according to the invention.

Specifically, FIG. 2 shows a test arrangement for determining the permeation rate of a polymer blister, where (1) is the capacitance measuring device, (2) is the filling station for the electrically conductive liquid, (E1) is the electrode 1, (E2) is the electrode 2, (3) is the electrically conductive liquid and (4) is the workpiece that is to be measured (packaging component, e.g. blister well).

FIG. 3 shows, on the left, a calibration film (A) contacted with conductive silver and, on the right, a blister cavity (B) with the electrodes (E1) and (E2).

In another embodiment, the present invention comprises a device that can be used in mobile operation for rapidly determining average layer thickness and permeation rate in any desired packaging system. Such a device is suitable for measuring the average layer thickness and the permeation rate of any desired planar workpiece of a packaging system e.g. of a thermoformed base film of a blister card or the cover film of a blister card.

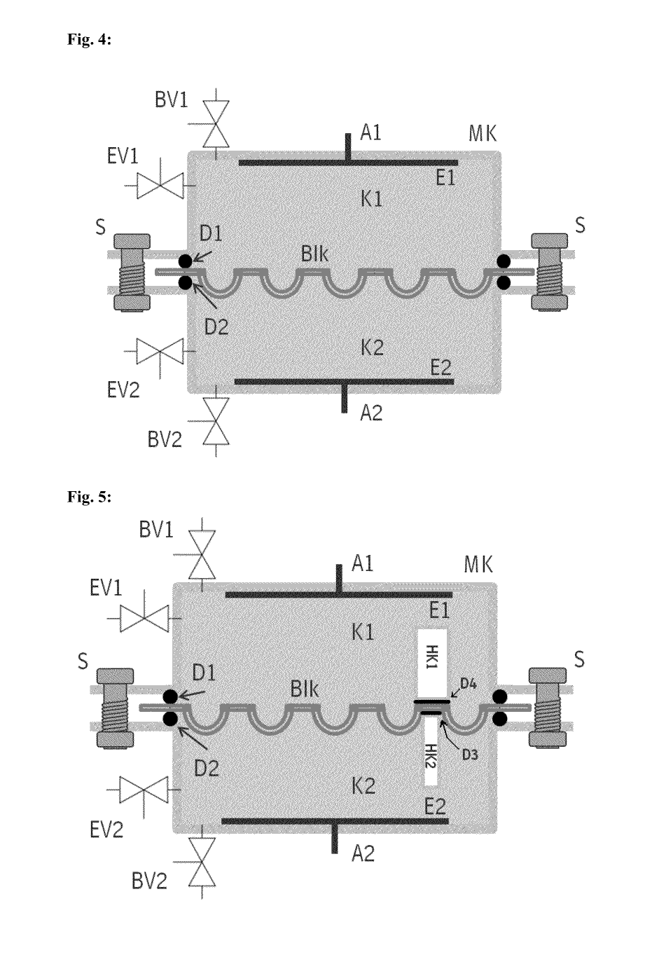

FIG. 4 shows the schematic structure of another embodiment of the device, comprising a measuring chamber (MK), which consists of 2 measuring chamber halves between which the workpiece that is to be measured (planar packaging component or planar packaging material or packaging bottle) is clamped and which constitutes a device according to the invention for measuring the specific surface/thickness ratio
A/l and for determining the permeation rate of a blister card.

The numerals shown in FIG. 4 have the following meanings:
Blk: workpiece to be measured, e.g. blister card (or planar packaging component
or planar packaging material)
MK: measuring chamber
K1, K2: measuring chamber halves 1 and 2
S: screw closure (alternatively clip or quick-release closure)
D1, D2: circumferential seals 1 and 2
EV1, EV2: fill valves 1 and 2
BV1, BV2: venting valves 1 and 2
E1, E2: electrode 1 and 2
A1, A2: electrical connections for the capacitive measurement

A particular device for determining the average layer thickness and the permeation rate on any desired packaging system particularly for a planar component of the packaging means comprises a measuring chamber (MK), which consists of 2 measuring chamber halves. The two measuring chamber halves are of cup-like configuration and are joined by means of a screw closure (S) so as to enclose a cavity. A planar packaging component, e.g. a blister card (Blk) is placed between these two measuring chamber halves, thereby annularly sealing off the two measuring chamber halves from the planar packaging component (Blk) placed therein by means of the circumferential seals (D1) and (D2). After the planar packaging component (Blk) has been inserted the measuring chamber can be tightly sealed by means of the screws (S), so that two individual separate chambers (K1) and (K2) are formed. The two measuring chamber halves (K1) and (K2) separated from one another are filled with an electrically conductive liquid through the filling valves (BV1) and (BV2). At the same time the measuring chamber halves (K1) and (K2) are totally vented through the venting valves (EV1) and (EV2), i.e. to eliminate any gas bubbles. (K1) and (K2) may be filled simultaneously or one after the other. The capacitive measurement can be carried out through the electrical connections (A1) and (A2) and the electrodes (E1) and (E2). To minimise errors it is particularly important that no gas bubbles whatsoever are present on the surface of the packaging during measurement.

In a preferred variant, the degassing of the two measuring chamber halves can be accelerated using ultrasound, by briefly subjecting the electrically conductive solution to ultrasound during the filling of the measuring chamber halves; in another variant, the degassing can be carried out by briefly applying negative pressure after the filling of the measuring chamber halves. In one variant, the total wetting or absence of gas bubbles on the surface of the packaging can be achieved by adding surface tension lower agents, e.g. surfactants, to the electrically conductive liquid.

Moreover, before the measurement, it is possible to check that the liquid has been adequately degassed for example by applying a rapidly oscillating volume change through one of the valves and simultaneously measuring the pressure profile through the same or another valve. All the other valves remain closed. Because of the high compressibility of any gas bubbles present, the pressure profile of conductive medium that has not been adequately degassed varies less than that of medium that has been adequately degassed. In this way the necessary degassed state of the medium can be ensured.

The electrically conductive liquid used may be for example a saline solution (e.g. a common salt solution). In a variant, the electrically conductive liquid may be an electrolyte. In another variant the electrically conductive liquid may be a suspension. In another special variant the electrically conductive liquid may be replaced by a conductive powder.

Another embodiment of the device for determining the average layer thickness and the permeation rate on any desired packaging system particularly for a planar component of the packaging means enables only a partial region of the planar component of the packaging means to be measured, in order to measure the average layer thickness and the permeation rate of a packaging means. This embodiment is thus suitable for measuring parts of blister cards, particularly for selecting the thermoformed cavity surfaces themselves. It thus makes it possible to carry out an even more exact inspection of the thermoformed regions that are crucial to quality.

FIG. 5 shows this special further embodiment by way of example. The numerals shown in FIG. 5 have the following meanings:
Blk: workpiece to be measured, e.g. blister card (or planar packaging component or planar packaging material)
MK: measuring chamber
K1, K2: measuring chamber halves 1 and 2
S: screw closure (alternatively clip or quick-release closure)
D1, D2: circumferential seals 1 and 2
EV1, EV2: fill valves 1 and 2
BV1, BV2: venting valves 1 and 2
E1, E2: electrodes 1 and 2
A1, A2: electrical connections for the capacitive measurement
HK1, HK2: hollow bodies 1 and 2, fitted with circumferential seals D3 and D4
D3, D4: circumferential seals 3 and 4

In this special embodiment—schematically shown in FIG. 5—all the non-thermoformed areas may be covered by hollow bodies (HK1, HK2, and other hollow bodies—not shown) and sealed with the seals D3 and D4 (additional circumferential seals for additional hollow bodies). The effect of this is that the regions covered are not wetted with conductive solution and thus do not contribute to the capacitive measurement. This ensures that parts of the blister card are excluded from the measurement and hence the measurement can be concentrated on target areas, for example particularly critical areas. The measurement is thus made more sensitive and more selective in a spatially resolved manner.

The device according to the invention, described hereinafter or hereinbefore, for determining the average layer thickness and the permeation rate of a packaging means can be embodied in a preferred variant, in terms of the size of the object that is to be measured (planar packaging component), so that only a single blister well of a blister may be inserted between the measuring chamber halves and measured.

As a further variant of the device the present invention encompasses an embodiment for the measurement of plastics bottles, which is characterised in that parts of a packaging (e.g. bottle base or wall section of the bottle) and alternatively the entire bottle can be clamped between the two chamber halves, the seal being provided between the measuring chamber halves (1) and (2) on the neck of the bottle.

The device according to the invention is particularly suitable for determining the average layer thickness and the permeation rate of packaging consisting of composite materials, individual components of which are electrically conductive, for example aluminium-based blisters. The conductive material is simultaneously used as an electrode for the capacitive measurement according to the invention.

In another preferred embodiment, the measuring chamber of the device according to the invention consists of a transparent material, for example glass, to make it possible to ascertain that no gas bubbles appear on the surface of the packaging during the measurement. For example, the measuring chamber halves may consist of a transparent or semi-transparent plastics. This may be PVC, acrylic or PET, for example. In another variant, the measuring chamber halves may be made from impact- and scratch-resistant and/or electrolyte-resistant plastics.

In the measuring arrangement/device described above the measurements/the method is carried out at constant temperature, preferably at ambient temperature. In a variant, measurements may be carried out at different controlled temperatures to increase the accuracy. This is determined by the dielectric properties of the barrier materials under investigation and by the electrical conductivity properties of the conductive liquid in the measuring chamber halves.

The invention also encompasses a method which, within the scope of a first step, carries out a detailed measurement of the permeation rate of a packaging component/a packaging using a method from the prior art (e.g. by gravimetry) and a comparative measurement on the basis of the capacitive determination of A/l according to the present invention, and in a second step an evaluation of the permeation rate of the packaging components that correspond to the production process can be carried out by exclusive measurement of A/l of other packaging components within the scope of an in-process control, for example. The measurements of step 1 can be taken once within the scope of the development of a packaging system and are used, over the entire life cycle of the packaging system, as a reference measurement for measurements according to the second step as a reference data set. The invention thus encompasses a method from a partial step 1 which makes it possible to determine the correlation between the capacitance measurement according to the method of the invention and the absolute permeation rate based on a method according to the prior art (and which corresponds to a calibration of the method) and a second step in which other workpieces of the same kind of packaging components as were used in step 1 can be investigated (use of the method as in-process control by evaluating the measurements according to step 2 and comparing the correlation between the capacitance and the permeation rate according to the measurements in step 1). This method encompasses steps 1 and 2 and can thus also be used when the permeation constant of the packaging material is not known. For example, the following method sequence is possible: the permeation rate is determined in a first test (e.g. gravimetric, with an analytical scale analogously to USP671). As a comparison, a capacitive determination of A/l of the packaging component that is to be investigated is carried out according to the present invention. Thus a link (calibration) is obtained between the capacitance and the permeation rate (step 1). Then, within the scope of a process for producing the packaging/packaging unit/packaging components, the capacitance of packaging units can be measured (as a random control and also as a 100% control) by the method according to the invention. If packaging units (or packaging or packaging components) are obtained during routine production whose capacitance differs significantly from the values stored for the calibration samples, this is a quick, direct and very telling indication of a possible deviation in quality in the production of the packaging/packaging unit/packaging component.

Moreover, this method of optimising, ensuring and monitoring the packaging quality can also be applied to the optimisation or confirmation of the successful reinstatement of changes in the machine or tooling, wear on the punches, changes of punches, after maintenance, quality-relevant shutdown of the machinery (e.g. associated with temperature changes).

In another application this method can also be used for optimising, ensuring and monitoring the quality of the packaging on the occasion of the removal of a machine or installation of a newly acquired packaging machine or after a move or other modifications, or in the event of a change to the production rate.

Besides the comparative method described above, it is possible, if the permeation coefficient of a raw packaging material (e.g. flat film) and the relative dielectric constant ∈ᵣ are known, to calculate the permeation rate of the packaging directly. This is possible by investigating a reference film (hereinafter also referred to as a calibrating film) of known thickness and area. ∈ᵣ is then obtained from

$${ɛ}_{r} = \frac{1}{{ɛ}_{0}} \cdot C \cdot \frac{l}{A} , \qquad ( 4 )$$

where ∈₀ is the dielectric constant of the vacuum (equation (4) thus constitutes a conversion of equation (2)).

By determining the value ∈ᵣ for a specific packaging means/packaging component, which as a material constant is specific to the quality (particularly the chemical composition) of the material of the packaging means/packaging component, and by determining the permeation coefficient (e.g. from Mocon measurements), the permeation rate can be calculated by measuring the capacity of a blister cavity (or of a bottle) using equation (1) (the basic assumption being that during the production of a blister cavity (or a bottle), i.e. during the thermoforming process (or blow-moulding process), or of another packaging component, the relative dielectric constant of the material does not change, as the dielectric properties of solids are determined in a first approximation by their molecular properties, which are not materially altered by their processing (shaping of the packaging component).

The invention also encompasses a method for quantitatively determining the permeation rate of the packaging material by measuring the dielectric properties of the packaging material. The method comprises steps 1 and 2 (description by way of example based on a blister cavity as a packaging component, which can also be applied directly to other moulded packaging parts, e.g. packaging bottles):
1. A flat film (of the same material quality as the packaging component that is to be examined) having a defined thickness (or a thickness that is determined by a method known from the prior art) and a defined area A (or an area A which is determined by a prior-art method) is used as the calibrating film. Then a plate capacitor is made from this film, the calibrating film acting as a dielectric between the plates of the plate capacitor. This can be done by placing the blister cavity (calibrating film) in the device according to the invention or by other methods known from the prior art. By measuring the electrical capacitance at one or more frequencies and using the geometric magnitudes A/l of the calibrating film the relative dielectric constant can then be calculated as a material constant. The relative dielectric constant as a material constant is characteristic of the film that is used for the packaging component that is to be examined.
2. The blister cavity is provided with electrodes analogously to the flat film and then the capacitance is measured. It is important that the entire surface contributing to the permeation (the thermoformed part, in the case of a blister) is included. The permeation rate can be determined from the capacitance with a known relative dielectric constant and a known permeation coefficient. The measurement is carried out using the device according to the invention.
It is sufficient to carry out the process according to point 1 once until a change of material, for example, as step 1 determines a material constant specific to the packaging material used. Thus it is sufficient that only the method according to point 2 has to be carried out for routine investigations, in order to detect differences in the geometric shaping and the associated change in the permeation rate.

This method of measurement is of particular advantage in determining the permeation rate for systems with very long relaxation times. This is the case for example with PVdC (polyvinylidene chloride), where long relaxation times are imposed by a very low diffusion coefficient with regard to the movement of water vapour. As a result, permeation measurements on PVdC and hence on any system with a long relaxation time are very tedious in principle. The advantage, i.e. the considerable time saving of the method proposed according to the invention, is that the tedious part of the permeation measurement is separated off as a basic investigation and can thus be brought forward. This data set uses the method proposed here according to the invention to allow very fast and precise permeation measurement on site. In addition to the speed of the investigation its mobile operation is of very great advantage.

### Specific Embodiment

The following is a description of how the capacitive method of measurement described in the patent application is used within the scope of the packaging development for a product that is in development, so as not to exceed a maximum permeation threshold and hence not to exceed a maximum moisture content of the product that is critical to stability during storage. First of all the packaging suitable for a product that is connected with a desired value for the permeation rate and the associated capacitance is determined. In the case of a moisture-sensitive product, the water content is a decisive stability criterion which is determined by the permeation rate of the packaging among other things and can thus be calculated in advance by capacitive measurements. The desired value for the permeation rate is imposed by a desired value for water content after storage, including the period of use, as defined in the plan (cf. the black curve in FIG. 6). Allowing for a safety buffer for the stability-critical moisture content (broken red line) a threshold value for the permeation rate is defined (associated with the red curve in FIG. 6). These two values are clearly connected to desired and threshold capacitance values by means of formula (3). Thus, the advantage of the method according to the invention is that with a capacitive measurement the permeation of a packaging can be quantitatively determined from the measured capacitance of the permeation-relevant packaging part, using the method described above. A threshold value for the permeation rate can be immediately detected in the form of a threshold value for the capacitance, which can be measured very quickly and accurately. Another advantage of this method is the fact that it can be used for very different types of packaging incl. packaging components and moreover is suitable for mobile use. Analogous considerations can be applied to the lower threshold of the permeation. In many packaging designs it may be essential not to fall below a minimum permeation rate. This can be checked using the method proposed here by defining threshold capacitances for minimum or in the case of packaging in humid corridors by defining both threshold capacitances.

In particular, the present invention also encompasses the use of the device according to the invention and/or the method according to the invention for determining the average layer thickness l of a planar packaging material.

In particular, the present invention also encompasses the use of the device according to the invention and/or the method according to the invention for determining the permeation rate \dot{m} of a packaging component for pharmaceutical packaging.

The invention also encompasses, for example, the particular embodiment of the invention for a packaging component in the shape of a hollow body (e.g. a bottle) in which the packaging component shaped as a hollow body is filled with an electrically conductive liquid and then sealed. Then the lid or the wall of the packaging component in the shape of a hollow body is pierced with a needle or a drill (both electrically conductive) in order to make contact with the inner electrode (=electrically conductive liquid).

It is important that the electrode inserted in the packaging component in the shape of a hollow body is insulated from the environment so as to avoid short circuits.

The packaging component in the shape of a hollow body is surrounded by an electrically conductive liquid that forms the outer electrode of the capacitor. By measuring the capacitance the integral ratio A/l is determined. With a known relative dielectric constant and the permeation coefficient, the permeation rate can be determined. Spatially resolved measurement can also be carried out by investigating the capacitance as a function of the fill level in the packaging component in the shape of a hollow body, so as to investigate thinning of the packaging component in the shape of a hollow body (e.g. the bottle base, walls, edges, corners). A packaging can also be inclined or laid down in order to examine special areas selectively.

It has proved advantageous that the method proposed here according to the invention is suitable for detecting any leaky areas in a packaging component in the shape of a hollow body (e.g. a bottle), as in this case a short circuit occurs between the two electrodes. Thus the measuring process proposed here is faster than the blue bath test and has the advantage that it does not require any deformation of bottles caused by the applied pressure difference (principle of the blue bath test).

In addition to a finding of “leaktight” or “leaky” the capacitive method proposed here provides information as to how high the permeation rate is in apparently intact packaging components in the shape of a hollow body (e.g. bottles). Thus, packaging components in the shape of a hollow body may optionally be rejected which would have been graded as “leaktight” in the blue bath test, but whose permeation rate would still be too great for the product to guarantee product stability over its shelf life. Another advantage of the capacitive measuring process proposed here by comparison with the blue bath test, besides the greater accuracy, is the shorter measuring time and hence the higher throughput of specimens for examination.

In addition, with the measuring process according to the invention, by an additional modulation of the water pressure in the packaging component in the shape of a hollow body, the measuring process can be used to simulate an evaluation of the bottles under stress conditions (e.g. transporting the bottles in an aircraft).

In another special application, the measuring process can also be used as follows for Al/Al blisters (blisters that consist of aluminium-based composite films). The typical construction of the cover and base film of an aluminium-based composite film look as follows:
base film, structure: 25 μm oPA/45 μm Al/60 μm PVC
cover film, structure: 25 μm Al soft

The cover film is sealed against the PVC of the base film. Thus the two Al layers can be used according to the invention as electrodes for the dielectric PVC located between them. It should be noted that in the Al/Al blister the PVC layer also extends in the cavity, where it does not contribute to the permeation rate but does contribute to the capacitance. However, this can easily be taken into account in the evaluation/modelling.

Besides the Al/Al blister the proposed method can also be used to examine an aluminium pouch that has a polymer layer, for example, inside it which is used for sealing. The capacitance measurement should be evaluated analogously to the Al/Al blister.

The invention also encompasses a measuring process for the spatially resolved measurement of the average layer thickness and the permeation rate of a blister or blister well, which is characterised in that the electrodes make contact with only a limited surface of the blister or the blister well or that only a small amount of electrolyte solution is introduced into the blister well (spatially resolved measurement).

In another variant, the measuring process can be used to test containers for inhalable solutions (for example FDD containers) that do or do not come into contact with the product, for their leaktight qualities and sufficient wall thickness.

In another variant, the capacitive method proposed here can be used to determine the wall thickness in bottles made of all materials that have no or very little conductivity (such as glass for example).

Analogously, the invention also encompasses the testing of packaging means and packaging components with regard to the permeation rate of gases other than water vapour, particularly oxygen.

1. Device for determining the average thickness l of a planar material, particularly blisters and/or bottles, by means of a capacitive measurement, wherein opposing outer surfaces of the material are provided with electrodes, so that by measuring the capacitance with a known material-specific relative dielectric constant ∈ᵣ and a known area A of the electrodes the average thickness l can be obtained, the device comprising electrodes between which the packaging material is inserted and the electrode surface A corresponding to the surface of the packaging means between the surfaces of which the average layer thickness is to be determined.

2. Device according to claim 1, characterised in that the device consists of a measuring chamber into which the packaging material is clamped, so that two separate measuring chamber halves are produced which are separated by the packaging material, the two opposing surfaces of the packaging material in the two measuring chamber halves being connected to the electrodes.

3. Device according to claim 1, characterised in that the measuring chamber halves are filled with an electrically conductive liquid, so that the opposing surfaces of the packaging material between which the average layer thickness is to be determined are electrically conductively connected to the electrode connections.

4. Method of determining the average layer thickness l of a planar packaging material for pharmaceutical packaging, particularly blisters and/or bottles, wherein the capacitance is measured by means of two electrodes applied to the opposing outer surfaces of the packaging material, so that the average layer thickness l can be calculated by means of the material-specific relative dielectric constant ∈ᵣ and the known area A of the electrodes, characterised in that in the method the electrode area A of the two electrodes corresponds to the area of the packaging between the surfaces of which the average layer thickness is to be determined.

5. Method of determining the average layer thickness l of a planar packaging material for pharmaceutical packaging according to claim 4 using a device according to claim 1.

6. Method of determining the permeation rate \dot{m} in of a planar packaging material for pharmaceutical packaging within the scope of quality control inspections of packaging components, comprising the partial steps (i) and (ii), where
(i) denotes the measurement of the permeation rate \dot{m} of a planar packaging material by a method known in the prior art and measurement of the capacitance on the basis of the method according to claim 4 or 5, and assigning the value of the capacitance measurement to the permeation rate \dot{m} and
(ii) denotes the measurement of the capacitance, on the basis of the method according to claim 4, of other workpieces of the planar packaging material for pharmaceutical packaging within the scope of quality control inspections of packaging components.

7. Method for quantitatively determining the permeation rate \dot{m} of a packaging component for pharmaceutical packaging comprising the partial steps (a) and (b), where
(a) comprises determining the relative dielectric constant ∈ᵣ on a flat film (=calibrating film), this flat film having a defined thickness (or a thickness which is determined by a method known from the prior art) and a defined area A (or the area A is determined by a method according to the prior art) and the calibrating film has the same material quality (composition) as the packaging component that is to be inspected and
(b) comprises determining the capacitance C of the packaging component, wherein the opposing outer surfaces of the packaging component are provided with electrodes and the electrode area A of the two electrodes corresponds to the area of the packaging component, for whose area the ratio A/l is to be integrally determined,
and the permeation rate \dot{m} can be obtained by inserting the measured value in the equation
$$\dot{m} = P \frac{A}{l} Δ {P}_{{H}_{2} O} \frac{{M}_{{H}_{2} O} {P}_{0}}{R T}$$
when the permeation coefficient P is known.

8. Method for quantitatively determining the permeation rate \dot{m} of a packaging component for pharmaceutical packaging according to claim 7, characterised in that the determination of the capacitance C according to partial step (b) is carried out using a device according to claim 1.
